(19) United States
(12) Patent Application Publication
(10) Pub. No.: US 2026/0178764 A1
(43) Pub. Date: Jun. 25, 2026

(54) INFORMATION PROCESSING DEVICE AND CONCEALMENT SUPPORT METHOD

(71) Applicant: NEC Corporation, Tokyo (JP)

(72) Inventors: Joe BRINTON, Tokyo (JP); Masaki Inokuchi, Tokyo (JP); Masaharu Morimoto, Tokyo (JP); Yoshiaki Sakae, Tokyo (JP); Sian En Ooi, Tokyo (JP); Ryosuke Hotchi, Tokyo (JP); Tatsuya Fukuda, Tokyo (JP); Shunsuke Osaki, Tokyo (JP)

(73) Assignee: NEC Corporation, Tokyo (JP)

(21) Appl. No.: 19/421,145

(22) Filed: Dec. 16, 2025

(30) Foreign Application Priority Data
Dec. 24, 2024 (JP) 2024-227681

(51) Int. Cl. G06F 21/62

(52) U.S. Cl. CPC G06F 21/6218

(57) ABSTRACT

An information processing device includes one or more memories for storing instructions and one or more processors for executing the instructions. The one or more processors execute the instructions to acquire target data that may include a matter to be concealed, and estimate a target portion that is a portion to be concealed in the target data, using a language model trained with machine learning.

### INCORPORATION BY REFERENCE

This application is based upon and claims the benefit of priority from Japanese patent application No. 2024-227681, filed on Dec. 24, 2024, the disclosure of which is incorporated herein in its entirety by reference.

### TECHNICAL FIELD

The present disclosure relates to an information processing device, a concealment support method, and a program.

### BACKGROUND ART

A technique for concealing a part of a document is known. An example of a technique for concealing a part of a document is a document processing device described in JP 2020-149628 A. The document processing device divides target document data into sentences, and determines whether each sentence is a concealment target based on a preset concealment rule. Then, the document processing device executes concealment processing on the sentence determined to be a concealment target, and outputs document data including the sentence on which the concealment processing has been executed, that is, document data in which some sentences are concealed.

### SUMMARY

The document processing device described in JP 2020-149628 A determines whether each sentence is a target of concealment based on a preset concealment rule. In addition, the document processing device conceals the target sentence based on a preset concealment rule also in the concealment processing. However, information to be concealed generally varies, and it is not easy to create a concealment rule that can cover such various information. In particular, among proper nouns that are often subject to a high need for concealment, there are a huge number of existing proper nouns, and there are also proper nouns used only in some communities and newly created proper nouns. For this reason, it is extremely difficult to conceal all proper nouns by the concealment rule described in JP 2020-149628 A.

Therefore, in the present situation, it is necessary for a person to manually confirm the presence or absence of a portion to be concealed, and there is a problem that it cannot be said that the work related to concealment has been sufficiently improved in efficiency. The data to be concealed is not limited to document data. For example, even in a case where a part of image data (still image data or moving image data), audio data, or the like is concealed, there is a problem as described above.

The present disclosure has been made in view of the above problems, and an example object thereof is to provide a technique capable of improving efficiency of work related to concealment of data.

An information processing device according to an example aspect of the present disclosure includes: one or more memories for storing instructions; and one or more processors that execute the instructions, in which the one or more processors, by executing the instructions, acquire target data that may include a matter to be concealed, and estimate a target portion that is a portion to be concealed in the target data, using a language model trained with machine learning.

Another information processing device according to an example aspect of the present disclosure includes: one or more memories for storing instructions; and one or more processors that execute the instructions, in which the one or more processors, by executing the instructions, specify a target portion to be concealed in target data, and estimate a mode of concealment to be applied to the specified target portion, using a language model trained with machine learning.

In a concealment support method according to an example aspect of the present disclosure, at least one processor executes data acquisition processing of acquiring target data that may include a matter to be concealed, and target portion estimation processing of estimating a target portion that is a portion to be concealed in the target data, using a language model trained with machine learning.

A concealment support program according to an example aspect of the present disclosure causes a computer to function as: a data acquisition means for acquiring target data that may include a matter to be concealed; and a target portion estimation means for estimating a target portion that is a portion to be concealed in the target data, using a language model trained with machine learning.

According to an exemplary aspect of the present disclosure, there is an exemplary effect that it is possible to provide a technique capable of improving efficiency of work related to concealment of data.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of a concealment support method according to the present disclosure;

FIG. 3 is a block diagram illustrating a configuration of another information processing device according to the present disclosure;

FIG. 4 is a diagram illustrating an example of processing of estimating a concealment target portion;

FIG. 5 is a diagram illustrating a display screen example for presenting the concealment target portion;

FIG. 6 is a diagram illustrating a display screen example for accepting selection or correction of a conversion candidate;

FIG. 7 is a diagram illustrating an example of processing of estimating a mode of concealment to be applied;

FIG. 8 is a diagram illustrating an example of a display screen for selecting a form of conversion to be applied;

FIG. 9 is a diagram illustrating another example of a display screen for selecting a form of conversion to be applied;

FIG. 10 is a flowchart illustrating a flow of processing of specifying a concealment target portion;

FIG. 11 is a flowchart illustrating a flow of processing of generating concealed data;

FIG. 12 is a block diagram illustrating a configuration of an information processing device according to a reference example; and

FIG. 13 is a block diagram illustrating a configuration of a computer that functions as an information processing device according to the present disclosure.

### EXAMPLE EMBODIMENTS

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in each of the following exemplary example embodiments can also be included in the scope of the present disclosure.

Further, each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technology illustrated in the drawings referred to for describing the present exemplary example embodiment may also be adopted in another exemplary example embodiment included in the present disclosure within a range in which no particular technical problem occurs.

### (Configuration of Information Processing Device 1)

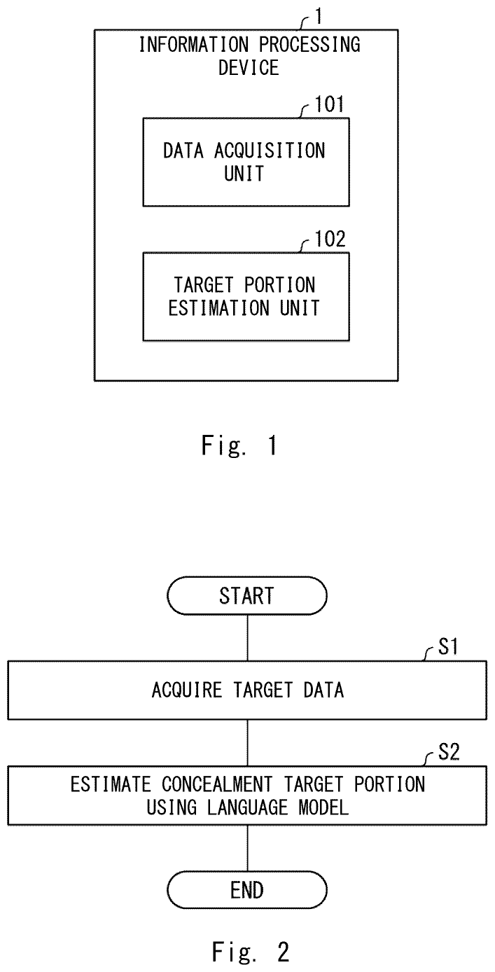

A configuration of an information processing device 1 will be described with reference to FIG. 1. FIG. 1 is a block diagram illustrating a configuration of the information processing device 1. As illustrated in FIG. 1, the information processing device 1 includes a data acquisition unit 101 and a target portion estimation unit 102.

The data acquisition unit 101 acquires target data that may include a matter to be concealed. Here, concealment means to prevent the content from being disclosed. For example, processing such as deleting a portion that is not desired to be disclosed and performing mask processing in such a way that the portion cannot be browsed is also included in the category of concealment. The concealment can also be called de-identification or the like. Hereinafter, performing the mask processing is referred to as masking. In addition, processing of replacing a portion that is not desired to be disclosed with contents that may be disclosed without any problem will also be described as an aspect of masking.

The target data may be any data that may include a matter to be concealed, and any electronic data can be set as the target data. For example, the target data may be document data (also referred to as text data), image data (still image data or moving image data), or audio data. The content of the target data is not particularly limited. For example, the target data may be an internal document scheduled to be disclosed to the outside of the company, may be recorded data obtained by recording a meeting, or may be document data such as a manuscript of news to be reported to the public. Furthermore, for example, the target data may be a medical document such as an electronic medical record. As described above, the information processing device 1 can also be applied to the healthcare field. Furthermore, a method of acquiring the target data is also freely selected, and for example, the data acquisition unit 101 may acquire the target data input to the information processing device 1 or may acquire the target data stored in the information processing device 1 or another device.

The target portion estimation unit 102 estimates a target portion that is a portion to be concealed in the target data, using a language model trained with machine learning. Hereinafter, the language model used by the target portion estimation unit 102 is referred to as a language model M.

The language model M is a model in which machine learning has been performed on a natural language. Here, machine learning on natural language more specifically means training of the arrangement of components (words and the like) in a sentence in a natural language and the arrangement of sentences in a text. The language model M that has been trained on natural language can output information useful for estimating an appropriate target portion according to the context of the target data or the like. Examples of the language model trained on natural language include bidirectional encoder representations from transformers (BERT), robustly optimized BERT approach (RoBERTa), efficiently learning an encoder that classifies token replacements accurately (ELECTRA), and the like. The language model M may be a general-purpose model that can be used for various applications, may be a model obtained by fine-tuning a general-purpose model for estimating a concealment target portion, or may be a dedicated model trained for estimating a concealment target portion.

Further, estimating the target portion using the language model M means directly or indirectly using the language model M in estimating the target portion. How to use the language model M in the estimation of the target portion is not particularly limited. For example, if the target data is text data described in a natural language, the target portion estimation unit 102 may input the target data as it is into the language model M and cause the target portion in the input target data to be inferred.

Furthermore, in a case where the target data is data in a non-text format, the target portion estimation unit 102 may convert the data into a text format and input the converted data to the language model M. As a method of converting the audio data into the text format and a method of converting the image data into the text format, for example, known methods such as various audio recognition technologies and optical character recognition (OCR) can be used. In addition, it is also possible to use image data as an input and convert the image data into a text format using a language model trained to output the content of the image data with machine learning. In a case where the target data is image data, it is not always necessary to convert the entire target data into text. For example, the target portion estimation unit 102 may estimate the concealment target portion from the text obtained by performing OCR on the character portion appearing in the image data.

In addition, some language models are configured and trained in such a way that non-text format data such as image data can be input. In a case where a language model capable of handling data in a non-text format is used as the language model M, the target portion estimation unit 102 can input the target data in the non-text format as it is to the language model M.

The target portion estimation unit 102 may directly use the output of the language model M as an estimation result, or may estimate the target portion based on the output of the language model M. In the former case, the target portion estimation unit 102 may cause the language model M to infer the target portion. In the latter case, the target portion estimation unit 102 may cause the language model M to output, for example, the candidate of the target portion and the certainty factor indicating the certainty that each candidate is the target portion, and may estimate the candidate with the certainty factor equal to or more than a predetermined threshold as the target portion.

Furthermore, the language model M may be stored in the information processing device 1 or may be stored in a server or the like outside the information processing device 1. In the latter case, the target portion estimation unit 102 may use the language model M via a server or the like that stores the language model M.

As described above, the information processing device 1 according to the present exemplary example embodiment employs a configuration including the data acquisition unit 101 that acquires target data that may include a matter to be concealed, and the target portion estimation unit 102 that estimates a target portion that is a portion to be concealed in the target data, using the language model M trained with machine learning.

According to the above configuration, since the target portion to be concealed in the target data is estimated using the language model M, it is possible to estimate the target portion according to the content of the target data without creating in advance the concealment rule described in the background art section. As a result, it is possible to obtain an effect of eliminating or reducing the effort of the work of manually confirming the target portion and improving the efficiency of the work related to concealment of data. Furthermore, by using the information processing device 1, it is also possible to optimize the entire work related to concealment of data.

How the target portion estimated by the target portion estimation unit 102 is used in concealing data may be freely selected. For example, the information processing device 1 may present the estimated target portion to the user. In this case, it is possible to cause the user to determine whether to conceal the presented target portion. Furthermore, for example, the information processing device 1 may automatically conceal the estimated target portion to generate concealed data. In this case, it is possible to automatically generate the concealed data from the target data without causing a burden of work of manually confirming the target portion.

### (Concealment Support Program)

The functions of the information processing device 1 described above can also be achieved by a program. A concealment support program according to the present exemplary example embodiment causes a computer to function as: a data acquisition means for acquiring target data that may include a matter to be concealed; and a target portion estimation means for estimating a target portion that is a portion to be concealed in the target data, using the language model M trained with machine learning. According to this concealment support program, it is possible to obtain an effect of improving the efficiency of the work related to concealment of data.

### (Flow of Concealment Support Method)

A flow of a concealment support method according to the present exemplary example embodiment will be described with reference to FIG. 2. FIG. 2 is a flowchart illustrating a flow of the concealment support method. An executing entity of each step in this concealment support method may be a processor included in the information processing device 1 or may be a processor included in another device. The executing entity of each step may be a processor provided in each of different devices.

In S1 (data acquisition processing), at least one processor acquires target data that may include a matter to be concealed.

In S2 (target portion estimation processing), at least one processor estimates a target portion that is a portion to be concealed in the target data acquired in S1, using the language model M trained with machine learning.

As described above, in the concealment support method according to the present exemplary example embodiment, a configuration is employed in which at least one processor executes data acquisition processing of acquiring target data that may include a matter to be concealed, and target portion estimation processing of estimating a target portion that is a portion to be concealed in the target data, using the language model M trained with machine learning. According to this concealment support method, it is possible to obtain an effect of improving the efficiency of the work related to concealment of data.

### Second Exemplary Example Embodiment

A second exemplary example embodiment that is an example of the example embodiments of the present disclosure will be described in detail with reference to the drawings. Components with the same functions as the components described in the above-described exemplary example embodiment will be denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing Device 1A)

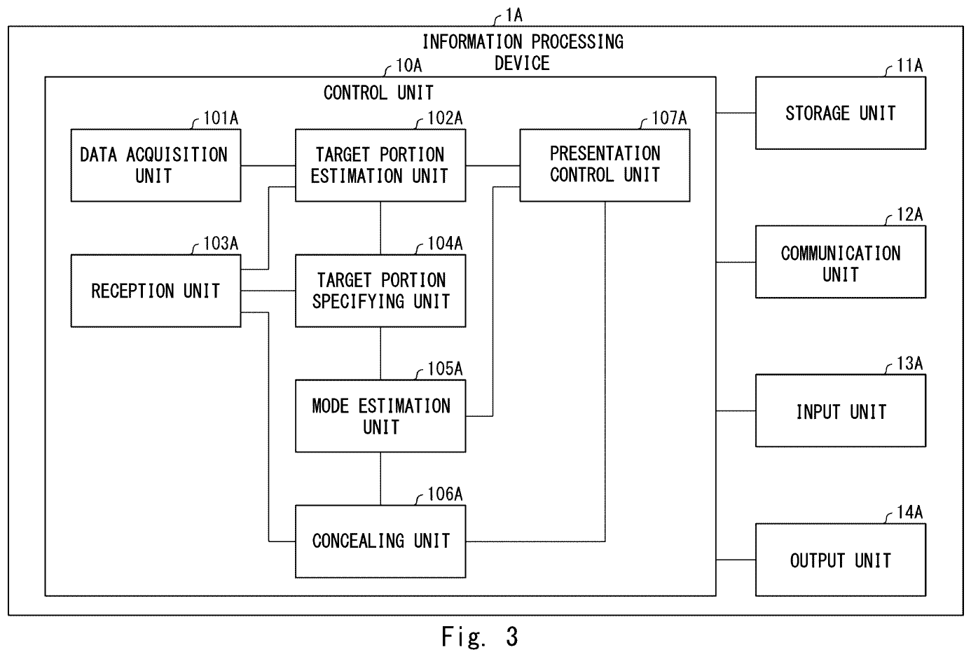

A configuration of the information processing device 1A will be described with reference to FIG. 3. FIG. 3 is a block diagram illustrating a configuration of the information processing device 1A. The information processing device 1A is a device with a function of supporting concealment of data. The information processing device 1A may be a local device used by individual users, or may be a server that provides a service for supporting concealment of data to a plurality of users.

As illustrated, the information processing device 1A includes a control unit 10A that integrally controls units of the information processing device 1A, and a storage unit 11A that stores various types of data to be used by the information processing device 1A. The information processing device 1A includes a communication unit 12A for the information processing device 1A to communicate with another device, an input unit 13A for accepting an input to the information processing device 1A, and an output unit 14A for the information processing device 1A to output data. Then, the control unit 10A includes a data acquisition unit 101A, a target portion estimation unit 102A, a reception unit 103A, a target portion specifying unit 104A, a mode estimation unit 105A, a concealing unit 106A, and a presentation control unit 107A.

Similarly to the data acquisition unit 101 of the first exemplary example embodiment, the data acquisition unit 101A acquires target data that may include a matter to be concealed. In the present exemplary example embodiment, an example in which the target data is document data in a text format will be described. For example, the data acquisition unit 101A may acquire target data input by the user of the information processing device 1A, that is, a person who conceals the target data via the input unit 13A. Furthermore, the data acquisition unit 101A may acquire the target data from another device (for example, a terminal device possessed by the user) via the communication unit 12A. Furthermore, the target data may be stored in the storage unit 11A or a storage device outside the information processing device 1A. In this case, the data acquisition unit 101A may access the storage unit 11A or the storage device to acquire the target data.

Similarly to the target portion estimation unit 102 of the first exemplary example embodiment, the target portion estimation unit 102A estimates a target portion to be concealed in target data using the language model M trained with machine learning. A method of estimating the target portion by the target portion estimation unit 102A will be described in detail later.

The reception unit 103A receives various instructions by the user. Although details will be described later, the reception unit 103A receives, for example, input of a matter desired to be concealed, designation of a portion to be concealed, and the like. Any method of receiving the instruction is applicable. For example, the reception unit 103A may receive an instruction input via the input unit 13A, or may receive an instruction from another device (for example, a terminal device used by the user) via the communication unit 12A.

The target portion specifying unit 104A specifies a target portion to be concealed in the target data. Specifically, the target portion specifying unit 104A specifies a portion of the target portion estimated by the target portion estimation unit 102A for which designation has been received by the reception unit 103A as a target portion to be concealed. That is, the target portion estimation unit 102A estimates candidates of the concealment target portion, and a portion designated by the user among the estimated candidates is specified as the concealment target portion by the target portion specifying unit 104A.

The mode estimation unit 105A estimates the mode of concealment to be applied to the target portion specified by the target portion specifying unit 104A using the language model M trained with machine learning. The mode of concealment may be any mode as long as the content of the target portion cannot be recognized or is difficult to recognize. For example, deleting the target portion from the target data, masking the target portion, and the like are one aspect of concealment. Furthermore, the mode estimation unit 105A may estimate what masking is to be applied as the mode of concealment. In the present exemplary example embodiment, an example in which the mode estimation unit 105A estimates how to convert the target portion, in other words, the conversion candidate of the target portion will be described.

The mode estimation unit 105A may estimate the mode of concealment to be applied to the target portion by using a language model different from the language model M used by the target portion estimation unit 102A. In that case, the target portion estimation unit 102A may use a fine-tuned language model for estimating the target portion, and the mode estimation unit 105A may use a fine-tuned language model for estimating the mode of concealment.

As described in the first exemplary example embodiment, the target data may be data in a non-text format such as image data or audio data. In a case where the target data is data in a non-text format, the mode estimation unit 105A may estimate the mode of concealment according to the format. For example, if the target data is image data, it can be concealed by masking, and thus the mode estimation unit 105A may estimate the mode of masking to be applied to the target portion of the image data. For example, the mode estimation unit 105A may estimate whether to mask the target portion with black, mask the target portion by mosaic processing, or mask the target portion by superimposing another image. Furthermore, for example, in a case where the target data is audio data, the portion can be concealed by superimposing another audio on the portion. Therefore, the mode estimation unit 105A may estimate the audio to be superimposed on the target portion of the audio data.

Furthermore, although details will be described later, the mode estimation unit 105A can estimate a plurality of conversion candidates for one target portion. For example, in a case where a place name “XYZ city” appearing in the image data is a target portion to be concealed, the mode estimation unit 105A can estimate a plurality of conversion candidates such as “certain city”, “certain large city”, and “certain city in the metropolitan area”. As described above, according to the information processing device 1A, it is also possible to conceal target data in a non-text format such as image data in a mode according to the user's intention.

The concealing unit 106A conceals the target portion in the target data to generate concealed data. As described above, the target portion in the target data is a portion designated by the user as a concealment target among the target portions estimated by the target portion estimation unit 102A. Furthermore, although details will be described later, the mode of concealment is determined based on the estimation result of the mode estimation unit 105A.

Note that, in a case where the target data is image data, a part of the image data (for example, a part in which a human face appears) may be set as a concealment target portion. In that case, the concealing unit 106A may generate the concealed data by detecting the position and range of the target portion in the target data using an object detection model trained with machine learning in such a way as to detect a region in which a predetermined object appears in the image data and masking the position and range in the target data.

The presentation control unit 107A presents various types of information necessary for concealment support to the user of the information processing device 1A. For example, the presentation control unit 107A may present the target portion estimated by the target portion estimation unit 102A. In that case, the reception unit 103A receives designation of a target portion to be concealed among target portions presented by the presentation control unit 107A. As a result, it is possible to smoothly conceal a portion that meets the user's intention.

The manner in which the presentation control unit 107A causes information to be presented on what device is freely determined. For example, the presentation control unit 107A can present various types of information in any form such as display, printing, audio, or a combination thereof. For example, in a case where the output unit 14A is a display device, the presentation control unit 107A may cause the output unit 14A to display and output various types of information.

As described above, similarly to the information processing device 1, the information processing device 1A includes the data acquisition unit 101A that acquires target data that may include a matter to be concealed, and the target portion estimation unit 102A that estimates a target portion to be concealed in the target data using the language model M trained with machine learning. Therefore, according to the information processing device 1A, it is possible to obtain an effect of improving the efficiency of the work related to concealment of data.

Furthermore, as described above, the information processing device 1A includes the mode estimation unit 105A that estimates the mode of concealment to be applied to the target portion using the language model M. As a result, in addition to the effects obtained by the information processing device 1, the determination of the mode of concealment is also automated or semi-automated, and it is possible to further improve the efficiency of the work related to the concealment of data.

### (Estimation of Concealment Target Portion)

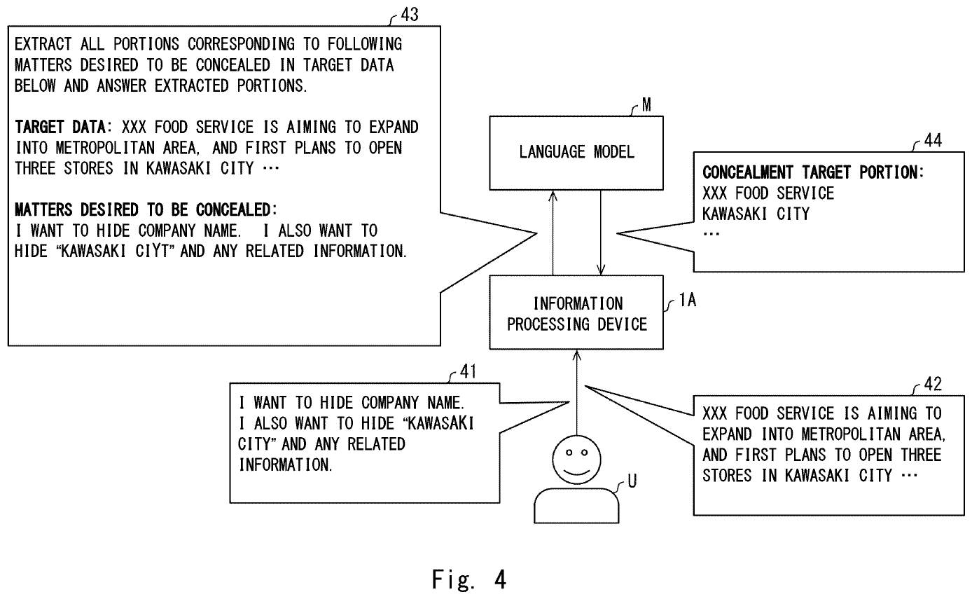

An outline of processing in which the target portion estimation unit 102A estimates a concealment target portion will be described with reference to FIG. 4. FIG. 4 is a diagram illustrating an example of processing of estimating a concealment target portion. In the example of FIG. 4, a user U inputs, to the information processing device 1A, a text 41 indicating a matter that the user U desires to conceal and target data 42 that is document data that may include a matter to be concealed. The input target data 42 is acquired by the data acquisition unit 101A, and the text 41 is received by the reception unit 103A.

In the text 41, a matter that the user U desires to conceal is represented in a natural language. Specifically, the text 41 includes a sentence “I want to hide the company name.” and a sentence “I also want to hide “Kawasaki City” and any related information.”. In this manner, the information processing device 1A (more precisely, the reception unit 103A) can also receive an input of a plurality of matters desired to be concealed. Furthermore, the reception unit 103A may receive an input of information abstractly indicating a matter desired to be concealed, such as “I want to hide the company name.”, or may receive an input of information directly indicating a matter desired to be concealed, such as “I also want to hide “Kawasaki City” and any related information.”. For example, the reception unit 103A may receive an input of any keyword desired to be concealed. In addition, the reception unit 103A may receive, for example, a specific company name, an individual name, an address, a telephone number, an e-mail address, confidential technical information, and the like as matters desired to be concealed.

Furthermore, the reception unit 103A may receive an input of information indirectly indicating a matter desired to be concealed. For example, the reception unit 103A may receive an input of information indicating the application of the target data. This is because the matter to be concealed can vary depending on the application of the target data. As a specific example, in a case where the target data is a news manuscript, the reception unit 103A may receive an input of information indicating that the target data is used for reporting. As a result, it is possible to estimate matters to be concealed (for example, description in which an address or the like of an individual can be specified) at the time of reporting as the target portion. Furthermore, for example, in a case where the target data is an internal document, the reception unit 103A may receive an input of information indicating that the target data is to be disclosed to the outside of the company. As a result, it is possible to estimate a portion where a confidential matter that should not be leaked to the outside of the company or a matter that has a problem in compliance if disclosed to the outside of the company is described as the target portion.

Next, the target portion estimation unit 102A estimates a target portion in the target data 42 based on the input text 41. Specifically, in the example of FIG. 4, the target portion estimation unit 102A generates a prompt 43 for instructing to extract the target portion from the target data 42. Then, the target portion estimation unit 102A inputs the generated prompt 43 to the language model M and outputs an answer 44 indicating the target portion in the target data 42.

The prompt 43 instructs to extract all portions corresponding to the matters desired to be concealed in the target data 42 and answer the extracted portions. Further, the prompt 43 includes a content of the target data 42 and a content of the text 41. Since the portions other than the contents of the target data 42 and the text 41 in the prompt 43 are fixed, these fixed portions can be templated in advance. In this case, the target portion estimation unit 102A can generate the prompt 43 by inputting the target data 42 and the text 41 to the template.

In the answer 44, descriptions of “XXX FOOD SERVICE” and “Kawasaki City” are shown as the target portions. “XXX FOOD SERVICE” is a description extracted based on a description of “I want to hide the company name.” in the text 41. On the other hand, “Kawasaki City” in the text 41 is a description extracted based on a description of “I also want to hide “Kawasaki City” and any related information.”.

The target portion estimation unit 102A only needs to generate a prompt capable of outputting information necessary for estimating the target portion, and the prompt is not limited to that illustrated in FIG. 4. For example, in a case where a matter to be concealed is not input, the target portion estimation unit 102A may generate a prompt including no matter desired to be concealed. In this case, the target portion estimation unit 102A may generate a prompt in a sentence such as “Please infer whether matters to be concealed are included in the following target data, and if included, extract and answer the matters.”.

Furthermore, the target portion estimation unit 102A may generate a prompt including various types of information for enhancing the estimation accuracy of the target portion according to the user's intention. For example, the target portion estimation unit 102A may generate a prompt including concealed sample data indicating data obtained by concealing a part thereof in the past and a portion concealed in the data. This prompt instructs to extract a portion of the target data 42 to be concealed with reference to the concealed sample data. As a result, it is possible to extract the target portion on the basis similar to that of the concealed sample data.

In addition, in a case where the input of the keyword desired to be concealed is received, the target portion estimation unit 102A may extract a portion related to the keyword from the target data 42 and generate a prompt for instructing to output the relevance that is an index value indicating the degree of relevance between the keyword and the extracted portion. In this case, the presentation control unit 107A can present a plurality of target portions related to one keyword in order of relevance with the keyword.

Furthermore, the target portion estimation unit 102A may extract a portion to be concealed from the target data 42 and generate a prompt for instructing to output a reason for extracting the portion. In this case, the presentation control unit 107A can present the target portion together with the reason why the target portion has been extracted.

As described above, the information processing device 1A may include the reception unit 103A that receives an input of a matter desired to be concealed, and the target portion estimation unit 102A may generate a prompt to instruct to extract a portion corresponding to the above matter from the target data. Then, the target portion estimation unit 102A may estimate the concealment target portion based on an output obtained by inputting the generated prompt to the language model M. As a result, in addition to the effect obtained by the information processing device 1, it is possible to estimate a portion corresponding to a matter that the user desires to conceal as the target portion.

### (Example of Display Screen for Selecting Target Portion to be Concealed)

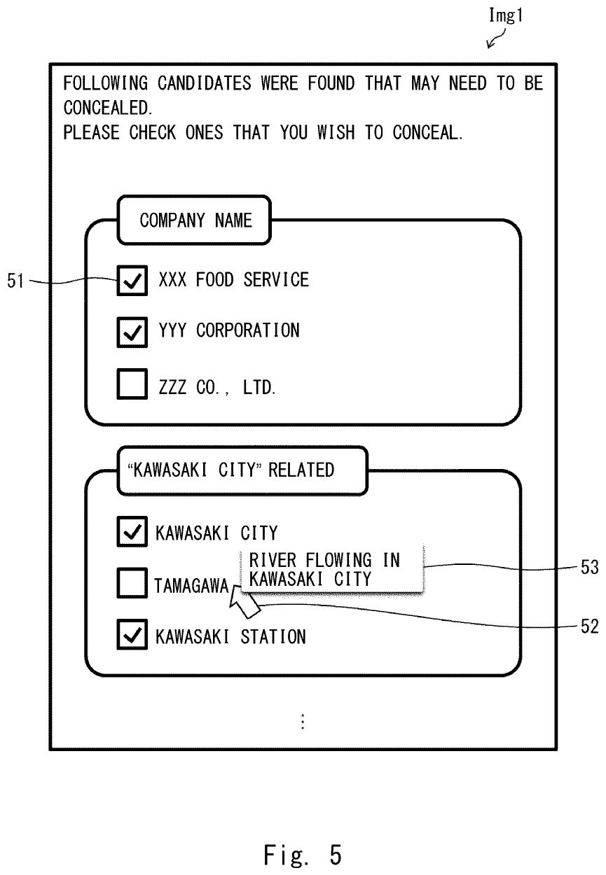

As described above, the presentation control unit 107A may present the target portion estimated by the target portion estimation unit 102A to the user. FIG. 5 is a diagram illustrating a display screen example for presenting the concealment target portion. In a screen example Img1 illustrated in FIG. 5, target portions estimated by the target portion estimation unit 102A are listed, and a check box 51 is displayed in association with each target portion. Furthermore, in the screen example Img1, a sentence prompting to check a portion to be concealed among the displayed target portions is displayed.

By displaying the display screen such as the screen example Img1, the user can check a portion that is considered to need to be concealed in the target data at once. In addition, the user can designate the target portion by a simple operation of operating a cursor 52 to check the check box 51. Then, the target portion specified by the user is specified as a concealment target portion by the target portion specifying unit 104A.

Furthermore, in the screen example Img1, the target portion is grouped for each matter that the user desires to conceal. That is, the target portion grouped as the “company name” in the screen example Img1 is a portion extracted based on the description of “I want to hide the company name.” in the text 41 illustrated in FIG. 4. Furthermore, in the screen example Img1, the target portion grouped as “related to “Kawasaki City” is a portion extracted based on the description of “I also want to hide “Kawasaki City” and any related information.” in the text 41 illustrated in FIG. 4.

Furthermore, in the screen example Img1, the cursor 52 is placed on the word “Tamagawa” that is one of the target portions, and accordingly, an object 53 indicating the reason why the word “Tamagawa” is extracted as the target portion is displayed. In this manner, the presentation control unit 107A may present the reason why the target portion has been extracted in response to the operation of selecting the presented target portion being performed. As a result, the user can determine whether to designate the target portion with reference to the presented extraction reason. As described above, the reason for extraction of the target portion can be output to the language model M.

As described above, the information processing device 1A includes the presentation control unit 107A that presents the target portion estimated by the target portion estimation unit 102A, and the reception unit 103A that receives designation of a target portion to be concealed among the target portions presented by the presentation control unit 107A. As a result, in addition to the effect obtained by the information processing device 1, it is possible to obtain an effect that a portion that meets the user's intention among the target portions estimated by the target portion estimation unit 102A can be set as a concealment target portion.

### (Example of Display Screen for Accepting Selection or Correction of Conversion Candidate)

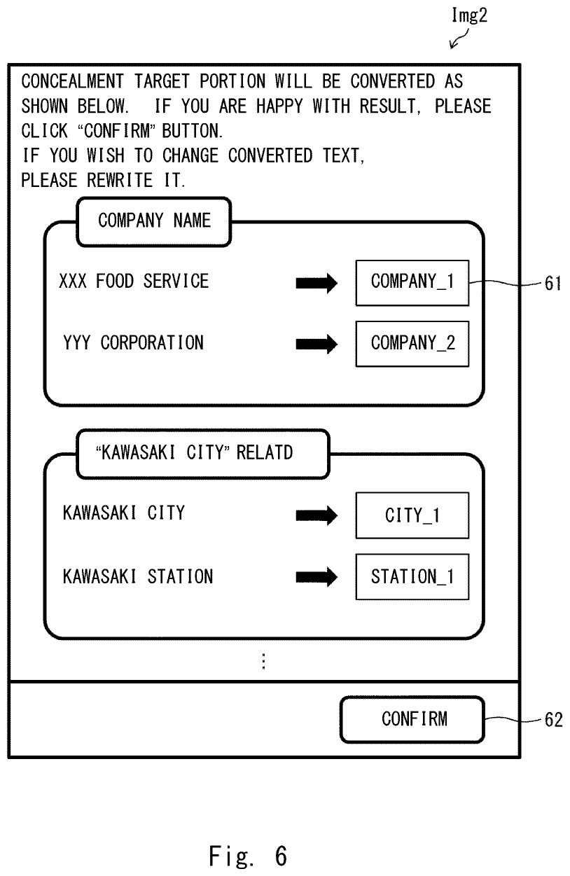

After the concealment target portion is specified as described above, the mode estimation unit 105A estimates the mode of concealment to be applied to the specified target portion. Then, as described above, the mode estimation unit 105A may estimate the conversion candidates of the target portion as the mode of concealment to be applied to the target portion. The presentation control unit 107A may present the conversion candidate estimated by the mode estimation unit 105A to the user. FIG. 6 is a diagram illustrating a display screen example for accepting selection or correction of a conversion candidate.

In a screen example Img2 illustrated in FIG. 6, target portions specified by the target portion specifying unit 104A are listed, and each target portion is displayed in association with its conversion candidate of the target portion. Furthermore, each target portion is grouped for each matter that the user desires to conceal, similarly to the screen example Img1 of FIG. 5. For example, in Img2, a target portion of “XXX FOOD SERVICE” is displayed in the group of “company name”. Then, a text box 61 in which a conversion candidate of “COMPANY_1” is displayed is displayed in association with the target portion. It is not always necessary to cause the mode estimation unit 105A to estimate the conversion candidates of each target portion, and the conversion candidates may be determined based on a rule or the like.

In addition, the screen example Img2 displays a sentence prompting to check whether the target portion can be converted into the conversion candidate displayed in the text box 61 and prompting to press the confirmation button 62 in a case where the conversion is possible. The confirmation button 62 is a software key. In a case where the reception unit 103A accepts the operation of selecting the confirmation button 62, the concealing unit 106A determines to convert each target portion into the conversion candidate displayed in each text box 61. The processing of converting the target portion into the conversion candidate can be rephrased as processing of replacing the target portion with the conversion candidate, processing of masking the target portion with the conversion candidate, or the like.

Furthermore, the screen example Img2 also displays a sentence prompting rewriting in a case where it is desired to change the converted description, that is, the conversion candidate. That is, in the screen example Img2, the text displayed in the text box 61 can be edited by the user. After the text displayed in the text box 61 is corrected, in a case where the reception unit 103A receives an operation of selecting the confirmation button 62, the concealing unit 106A determines to convert each target portion into a conversion candidate displayed in each text box 61, that is, a conversion candidate after correction.

As described above, the presentation control unit 107A may present a conversion candidate for concealing the target portion, and the reception unit 103A may receive selection or correction of the presented conversion candidate. Then, the concealing unit 106A may convert the target portion in the target data into the selected conversion candidate to generate the concealed data, or may convert the target portion in the target data into the corrected conversion candidate to generate the concealed data. As a result, in addition to the effect obtained by the information processing device 1, it is possible to obtain an effect that the user can correct the presented conversion candidates as necessary and generate the concealed data according to his/her intention while confirming with which conversion candidate the target portion is converted.

### (Estimation of Mode of Concealment to be Applied)

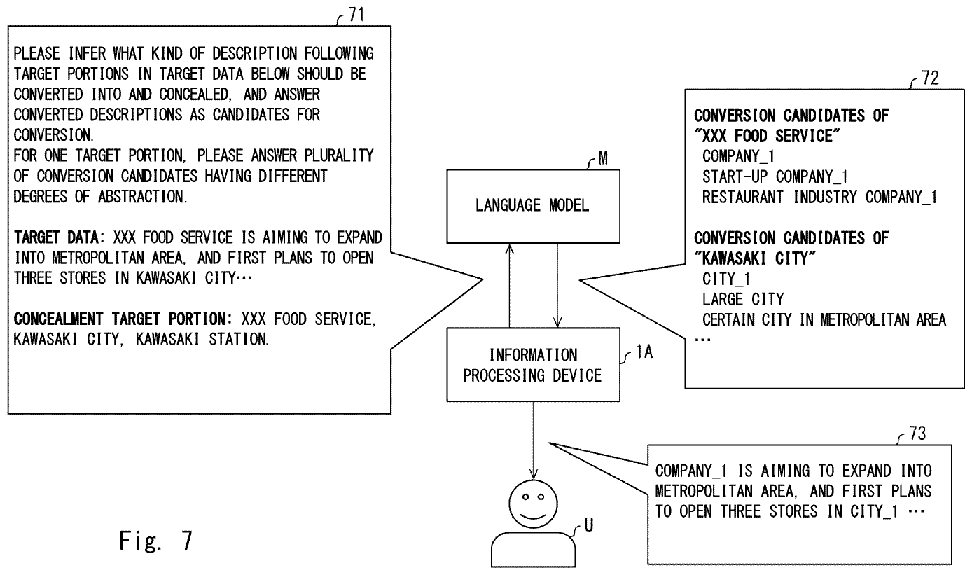

An outline of processing of estimating the mode of concealment to be applied by the mode estimation unit 105A will be described with reference to FIG. 7. FIG. 7 is a diagram illustrating an example of processing of estimating a mode of concealment to be applied. In the example of FIG. 7, a prompt 71 generated by the information processing device 1A (more precisely, the mode estimation unit 105A) is input to the language model M, and an answer 72 to the prompt 71 is output from the language model M. Then, the concealed data 73 generated based on the answer 72 is presented to the user U.

The prompt 71 instructs to answer the conversion candidate by inferring a mode of concealment to be applied, more specifically, what kind of description the target portion in the target data should be converted into and concealed. Furthermore, the prompt 71 includes a sentence instructing to answer a plurality of conversion candidates with different degrees of abstraction for one target portion. By including such a sentence, it is possible to easily generate concealed data according to the intention of the user U by generating conversion candidates with various degrees of abstraction. In addition, the mode estimation unit 105A may generate a prompt that specifies the directionality or perspective of abstraction, in other words, how to abstract. For example, the mode estimation unit 105A may generate a prompt for instructing to abstract each target portion in different directionalities to generate a plurality of conversion candidates.

In addition, the prompt 71 includes target data as well as each target portion. The mode estimation unit 105A can generate such a prompt by inputting the target portion specified by the target portion specifying unit 104A and the target data acquired by the data acquiring unit 101A to a predetermined template. Instead of the target portion specified by the target portion specifying unit 104A, the target portion estimated by the target portion estimation unit 102A may be input. In addition, it is not essential to include the target data in the prompt, but in a case where the target data is included, it is possible to estimate a mode of concealment to be applied to the target portion in consideration of the context of the target data. From the viewpoint of considering the context, the entire text of the target data is not necessarily included in the prompt, and a sentence including at least the target portion may be included in the prompt.

The mode estimation unit 105A only needs to generate a prompt capable of outputting information necessary for estimating the mode of concealment to be applied, and the prompt is not limited to that illustrated in FIG. 7. For example, the mode estimation unit 105A may generate a prompt that includes information indicating a matter input by the user U and desired to be concealed and instructs to estimate the mode of concealment to be applied with reference to the information. As a result, it is possible to infer an appropriate mode of concealment according to what kind of matter the user U desires to conceal.

Furthermore, for example, the mode estimation unit 105A may generate a prompt including conversion sample data indicating a concealment target portion in data that has been concealed in the past and a description of the target portion after conversion. This prompt instructs estimating a mode of concealment to be applied with reference to the converted sample data. As a result, it is possible to infer the mode of concealment to be applied on the basis similar to the reference of the converted sample data.

Furthermore, the mode estimation unit 105A may estimate the mode of concealment to be applied and generate a prompt for instructing to output a reason for recommending the mode. In this case, the presentation control unit 107A can present the mode of concealment to be applied together with the reason for recommendation.

In the answer 72 illustrated in FIG. 7, a plurality of conversion candidates with different degrees of abstraction for each target portion is illustrated. Specifically, three conversion candidates of “COMPANY_1”, “START-UP COMPANY_1”, and “RESTAURANT INDUSTRY COMPANY_1” are shown for the target portion “XXX FOOD SERVICE”. These are obtained by abstracting a specific company name of “XXX FOOD SERVICE”, but the degrees of abstraction are different. That is, while “COMPANY_1” is the most abstract and cannot be read at all from this description, “START-UP COMPANY_1” is a company just established, whereas “RESTAURANT INDUSTRY COMPANY_1” is a specific description to the extent that the industry type can be read.

The concealed data 73 illustrated in FIG. 7 is data generated by converting the concealment target portion in the target data 42 illustrated in FIG. 4 into the conversion candidate indicated in the answer 72. More specifically, the conversion candidate used in generating the concealed data 73 is the most abstract conversion candidate among the conversion candidates indicated in the answer 72. The conversion candidates to be used for generating the concealed data may be selected by the user U or may be automatically selected by the concealing unit 106A.

### (Example 1 of Display Screen for Selecting Form of Conversion to be Applied)

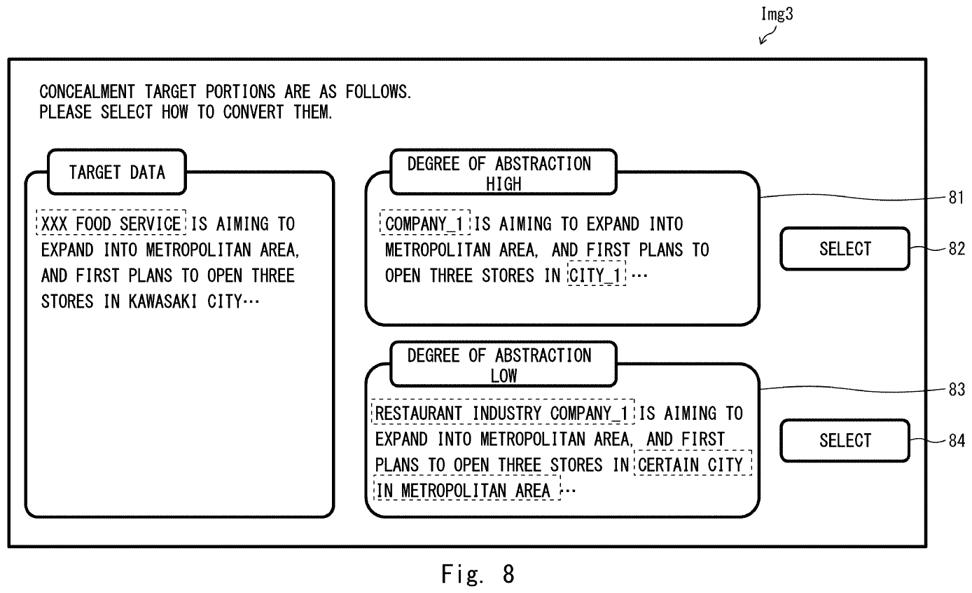

FIG. 8 is a diagram illustrating an example of a display screen for selecting a form of conversion to be applied. In a screen example Img3 illustrated in FIG. 8, target data is displayed. A concealment target portion in the target data is highlighted. In the screen example Img3, a preview image 81 of concealed data generated in a case where a conversion candidate with a high degree of abstraction is applied among a plurality of conversion candidates generated by the mode estimation unit 105A in the language model M is displayed. In the screen example Img3, a selection button 82 for selecting this conversion candidate is displayed. Furthermore, in the screen example Img3, a preview image 83 of concealed data generated in a case where a conversion candidate with a low degree of abstraction is applied among a plurality of conversion candidates generated by the mode estimation unit 105A in the language model M is displayed. In the screen example Img3, a selection button 84 for selecting this conversion candidate is displayed. In the preview images 81 and 83 of the concealed data, the converted portion is highlighted. Both the selection buttons 82 and 84 are software keys.

As described above, the presentation control unit 107A may present the concealment target portion in the target data in a state of being converted into the conversion candidate generated by the language model M. In other words, the presentation control unit 107A may display a preview of the concealed data generated in a case where the conversion candidate is applied. As a result, it is possible to cause the user to recognize what the concealed data generated in a case where the conversion candidate is applied will be and then determine whether the conversion candidate is applied.

In a case where the user determines that the mode of concealment shown in the preview image 81 is preferable, the user may perform an operation of selecting the selection button 82 displayed in association with the preview image 81. As a result, concealed data shown in the preview image 81 is generated. Similarly, in a case where the user determines that the mode of concealment shown in the preview image 83 is preferable, the user may perform an operation of selecting the selection button 84 displayed in association with the preview image 83. As a result, concealed data shown in the preview image 83 is generated.

Similarly to the example of FIG. 6, the reception unit 103A may receive user's correction to the mode of concealment presented by the presentation control unit 107A. As a result, a part of the mode of concealment displayed in the preview can be corrected in such a way as to conform to the user's intention.

### (Example 2 of Display Screen for Selecting Form of Conversion to be Applied)

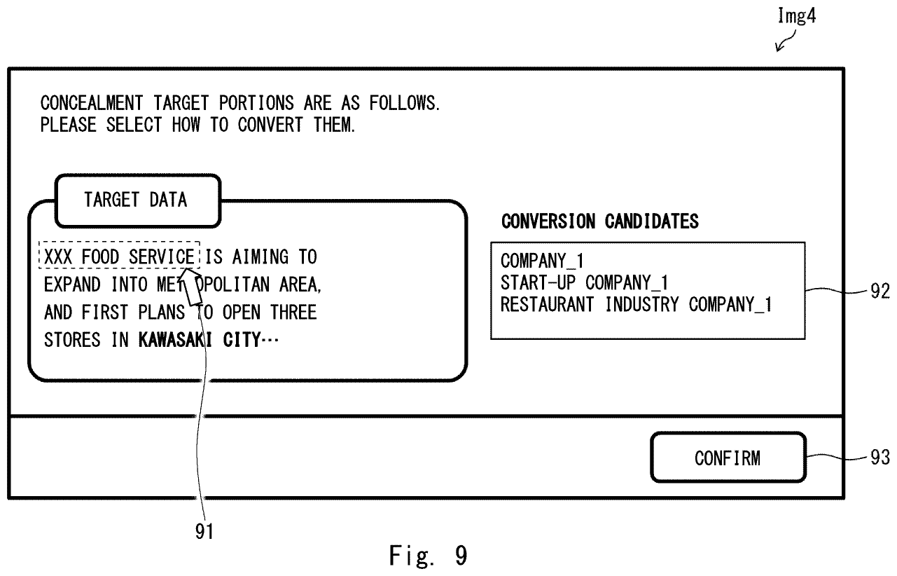

FIG. 9 is a diagram illustrating another example of a display screen for selecting a form of conversion to be applied. In a screen example Img4 illustrated in FIG. 9, target data is displayed similarly to the screen example Img3 of FIG. 8. In the target data illustrated in the screen example Img4, the concealment target portion is highlighted in bold, and the target portion (specifically, described as “XXX FOOD SERVICE”) selected by a cursor 91 is highlighted by marking. In this manner, the presentation control unit 107A may present the concealment target portion in the target data in such a way as to be distinguishable from other portions. Furthermore, the presentation control unit 107A may present the target portion designated by the user among the concealment target portions in a manner distinguishable from other target portions.

In the screen example Img4, conversion candidates of the target portion selected by the cursor 91 are listed in a display field 92. The user selects a conversion candidate to be applied to concealment of the target portion selected by the cursor 91 from among the listed conversion candidates and selects a confirmation button 93, so that the conversion of the target portion into the selected conversion candidate can be determined. For example, in a case where the user selects “RESTAURANT INDUSTRY COMPANY_1” with the cursor 91 and selects the confirmation button 93, it is determined that the description of “XXX FOOD SERVICE” in the target data is converted into the description of “RESTAURANT INDUSTRY COMPANY_1”.

As described above, the presentation control unit 107A may present the mode of concealment that has been estimated by the mode estimation unit 105A and is to be applied to the target portion, according to the operation of designating the presented target portion. For example, as in the example of FIG. 7, in a case where the language model M is caused to generate a plurality of conversion candidates obtained by abstracting the target portion with different abstraction degrees, the presentation control unit 107A may present the plurality of generated conversion candidates as in the screen example Img4. Then, the reception unit 103A may receive designation of a conversion candidate to be used for conversion of the target portion among the plurality of conversion candidates presented by the presentation control unit 107A. The designated conversion candidate is used for generation of concealed data by the concealing unit 106A.

The presentation control unit 107A may present a preview image obtained by converting the target portion in the presented target data into the designated conversion candidate in response to designation of any of the plurality of presented conversion candidates.

The manner of presenting the plurality of conversion candidates is freely selected, and is not limited to the example of FIG. 9. For example, the presentation control unit 107A may display a list of each conversion candidate of each target portion regardless of the operation of selecting the target portion with the cursor 91. As described based on FIG. 8, the presentation control unit 107A may present a plurality of conversion candidates by displaying a preview of concealed data generated in a case where the conversion candidate is applied for each of the plurality of conversion candidates.

Since the mode of concealment is not limited to conversion by the conversion candidates, the presentation control unit 107A may present candidates of the mode of concealment to be applied (for example, deletion or masking of a target portion, or the like) instead of presenting the conversion candidates. Also in a case where the candidates of the mode of concealment to be applied are presented, the presentation control unit 107A may display a preview of the concealed data generated in a case where the candidates are applied for each of the plurality of candidates as in the example of FIG. 8.

Similarly to the example of FIG. 6, the reception unit 103A may receive user's correction of the conversion candidate presented by the presentation control unit 107A. As a result, it is possible to apply the conversion candidate after correcting the conversion candidate in such a way as to follow the user's intention.

As described with reference to FIGS. 8 and 9, the mode estimation unit 105A may cause the language model M to generate a plurality of conversion candidates obtained by abstracting the target portion with different abstraction degrees, and the presentation control unit 107A may present a plurality of conversion candidates generated by the language model M. Then, the reception unit 103A may receive designation of a conversion candidate to be used for conversion of the target portion among the plurality of conversion candidates presented by the presentation control unit 107A. As a result, in addition to the effect obtained by the information processing device 1, it is possible to generate concealed data obtained by abstracting the target portion with the abstraction degree desired by the user.

As described based on FIG. 9, the presentation control unit 107A may present the target portion together with the target data, and may present the mode of concealment to be applied to the target portion estimated by the mode estimation unit 105A according to the operation of designating the presented target portion. As a result, in addition to the effect obtained by the information processing device 1, it is possible to obtain an effect that the mode of concealment to be applied to the target portion specified by the user in the target data can be recognized.

### (Process Flow: Identification of Concealment Target Portion)

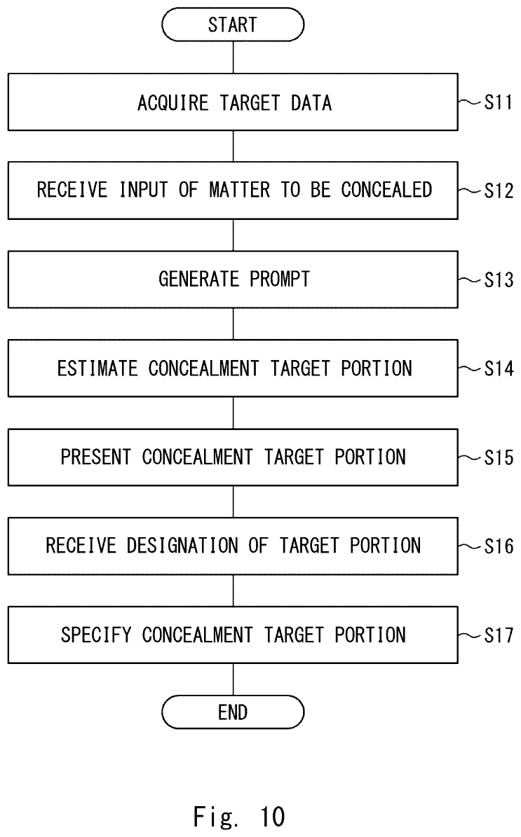

A flow of processing executed in a case where the information processing device 1A specifies a concealment target portion will be described with reference to FIG. 10. FIG. 10 is a flowchart illustrating a flow of processing of specifying a concealment target portion. The flowchart of FIG. 10 includes each processing of the concealment support method according to the present exemplary example embodiment.

In S11 (data acquisition processing), the data acquisition unit 101A acquires target data that may include a matter to be concealed. In S12, the reception unit 103A receives an input of a matter that the user desires to conceal. The processing of S12 may be performed before S11, or the processing of S11 and S12 may be performed in parallel. The processing of S12 can be omitted.

In S13, the target portion estimation unit 102A generates a prompt for instructing to output information necessary for estimating the concealment target portion in the target data. For example, the target portion estimation unit 102A may generate a prompt by inputting the target data acquired in S11 and the matter desired to be concealed received in S12 to a template of a prompt to instruct the user to extract a portion corresponding to the matter desired to be concealed from the target data. This can generate a prompt, for example, prompt 43 in FIG. 4.

In S14 (target portion estimation processing), the target portion estimation unit 102A estimates a target portion that is a portion to be concealed in the target data acquired in S11, using the language model M trained with machine learning. Specifically, the target portion estimation unit 102A inputs the prompt generated in S13 to the language model M. Then, the target portion estimation unit 102A estimates the target portion based on the output of the language model M.

In S15, the presentation control unit 107A presents the target portion estimated in S14 to the user. Then, in S16, the reception unit 103A receives designation of a target portion to be concealed among the target portions presented in S15.

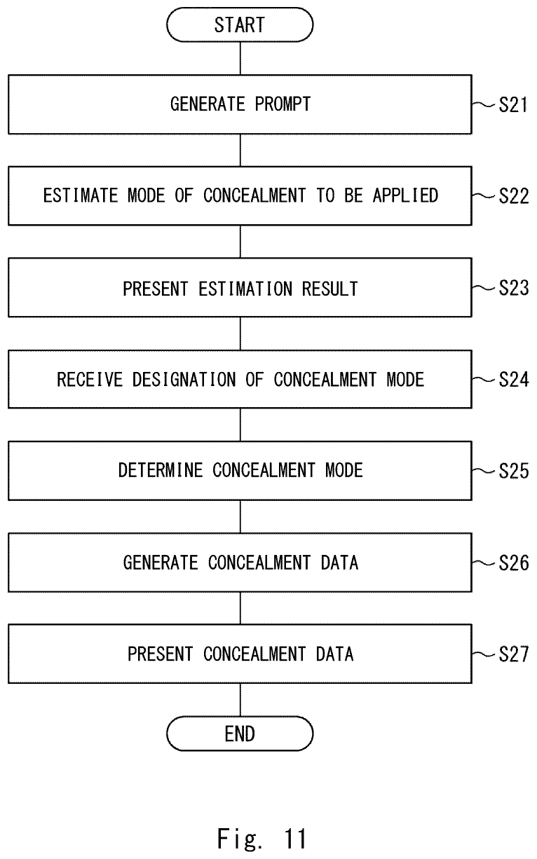

In S17 (target portion specifying processing), the target portion specifying unit 104A specifies a target portion to be concealed in the target data acquired in S11. Specifically, the target portion specifying unit 104A specifies the target portion designated by the user in S16 among the target portions presented in S15 as the concealment target portion. Accordingly, the processing of FIG. 10 ends. After completion of S17, the processing of S21 in FIG. 11 is started.

The target portion estimated in S14 may be set as a concealment target portion without causing the user to confirm the target portion. In this case, S14 is the target portion specifying processing of specifying the concealment target portion, and the processing after S15 is omitted. Then, the processing of FIG. 11 described later is performed on the specified target portion.

### (Flow of Processing: Generation of Concealed Data)

A flow of processing executed in a case where the information processing device 1A generates concealed data will be described with reference to FIG. 11. FIG. 11 is a flowchart illustrating a flow of processing of generating concealed data. The flowchart of FIG. 11 also includes processing of the concealment support method according to the present exemplary example embodiment.

In S21, the mode estimation unit 105A generates a prompt for instructing to output information necessary for estimating the mode of concealment to be applied to the concealment target portion. This target portion is the portion specified by the target portion specifying unit 104A in S17 of FIG. 10. For example, the mode estimation unit 105A may generate a prompt by inputting the target data acquired in S11 of FIG. 10 and the target portion specified in S17 of FIG. 10 to a template of a prompt to instruct to answer the conversion candidate of the concealment target portion in the target data. As a result, for example, the mode estimation unit 105A can generate a prompt such as the prompt 71 in FIG. 7.

In S22 (mode estimation processing), the mode estimation unit 105A estimates the mode of the concealment to be applied to the target portion specified in S17 of FIG. 10 using the language model M trained with machine learning. Specifically, the mode estimation unit 105A inputs the prompt generated in S21 to the language model M. Then, the mode estimation unit 105A estimates the mode of concealment based on the output of the language model M.

In S23, the presentation control unit 107A presents the estimation result of S22, in other words, the candidate of the mode of concealment to be applied to the target portion to the user. Then, in S24, the reception unit 103A receives the designation of the mode of concealment to be applied to the target portion. For example, the reception unit 103A may cause the user to select any one of the candidates presented in S23 to designate a mode of concealment to be applied to the target portion. As described based on FIG. 6, the reception unit 103A may receive user's correction to the mode of concealment presented by the presentation control unit 107A.

In S25, the concealing unit 106A determines a mode of concealment to be applied to the target portion in accordance with the designation received in S24. For example, in a case where a certain conversion candidate for a certain target portion is selected in S24, the concealing unit 106A determines to convert the target portion into the conversion candidate. In a case where there is a plurality of target portions, the concealing unit 106A determines a mode of concealment for each target portion.

In S26, the concealing unit 106A conceals the target portion in the target data in the mode determined in S25, and generates the concealed data. Then, in S27, the presentation control unit 107A presents the concealed data generated in S26 to the user. Accordingly, the processing of FIG. 11 ends. It is not essential to present the generated concealed data to the user. For example, the concealing unit 106A may store the generated concealed data in the storage unit 11A or the like without causing the presentation control unit 107A to present the generated concealed data.

### Reference Example

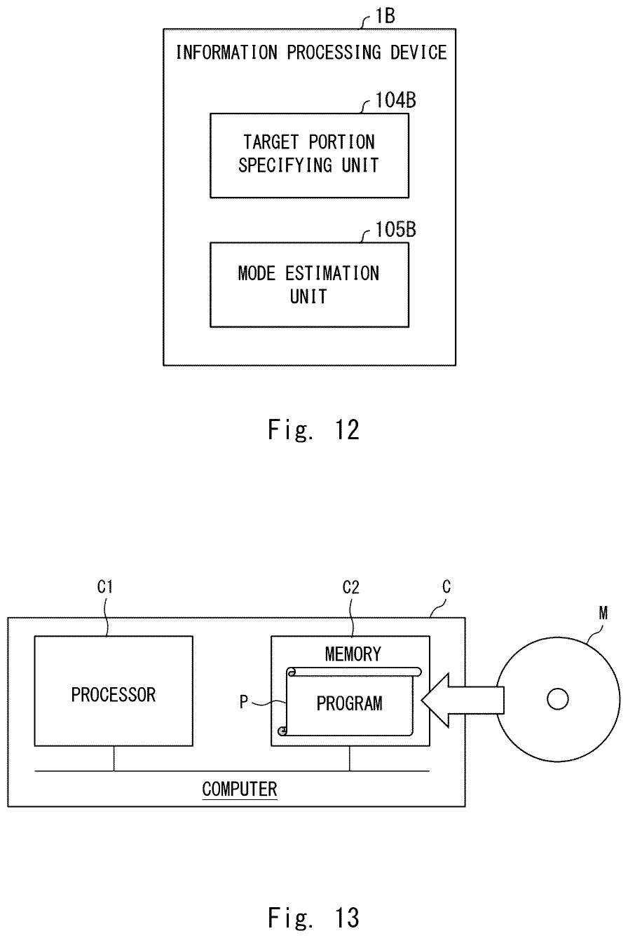

FIG. 12 is a block diagram illustrating a configuration of an information processing device 1B according to the present reference example. As illustrated, the information processing device 1B includes the target portion specifying unit 104B and the mode estimation unit 105B.

The target portion specifying unit 104B specifies a target portion to be concealed in the target data. It is similar to the first and second exemplary example embodiments that the target data may be any electronic data.

Any method of specifying the target portion by the target portion specifying unit 104B may be used. For example, the target portion specifying unit 104B may specify a portion designated by the user in the target data as the target portion. The designation by the user can be received via an input unit or a communication unit (not illustrated).

Furthermore, the information processing device 1B may be provided with the target portion estimation unit 102A described in the second exemplary example embodiment. In this case, the target portion specifying unit 104B only needs to specify a portion designated by the user among the target portion estimated by the target portion estimation unit 102A or the target portion estimated by the target portion estimation unit 102A as the target portion.

Similarly to the mode estimation unit 105B of the second exemplary example embodiment, the mode estimation unit 105A estimates the mode of concealment to be applied to the target portion specified by a target portion specifying unit 104B using the language model M trained with machine learning.

As described above, the information processing apparatus 1B includes the target portion specifying unit 104B that specifies the target portion to be concealed in the target data, and the mode estimation unit 105B that estimates the mode of concealment to be applied to the target portion specified by the target portion specifying unit 104B using the language model M trained with machine learning.

According to the above configuration, since the mode of concealment using the language model M is estimated, it is possible to estimate the mode of concealment according to the content of the target data without creating in advance the concealment rule described in the background art section. As a result, it is possible to obtain an effect that it is possible to eliminate or reduce the burden of work for a person to consider and determine the mode of concealment and to improve the efficiency of work related to concealment of data. Furthermore, by using the information processing device 1, it is also possible to optimize the entire work related to concealment of data.

### (Concealment Support Program)

The above-described functions of the information processing device 1B can also be achieved by a program. A concealment support program according to the present reference example causes a computer to function as: a target portion specifying means for specifying a target portion to be concealed in target data; and a mode estimation means for estimating a mode of concealment to be applied to the target portion specified by the target portion specifying means, using a language model M trained with machine learning. According to this concealment support program, it is possible to obtain an effect of improving the efficiency of the work related to concealment of data.

### (Concealment Support Method)

In the concealment support method according to the present reference example, at least one processor executes target portion specifying processing of specifying a target portion to be concealed in target data, and mode estimation processing of estimating a mode of concealment to be applied to the target portion specified in the target portion specifying processing using a language model M trained with machine learning. According to this concealment support method, it is possible to obtain an effect of improving the efficiency of the work related to concealment of data.

### MODIFIED EXAMPLES

Any execution subject of each processing described in the above-described exemplary example embodiment and reference example is applicable, and is not limited to the above-described examples. For example, a system including functions similar to those of the information processing devices 1, 1A, and 1B can be constructed by a plurality of devices capable of communicating with each other. The executing entity of each processing illustrated in the flowchart of FIGS. 10 and 11 may be one device (may be rephrased as a processor) or a plurality of devices (may be similarly rephrased as processors).

### Example of Implementation by Software

Some or all of the functions of the information processing devices 1, 1A, and 1B (referred to below also as “each of the devices above”) may be implemented by hardware such as an integrated circuit (IC chip) or may be implemented by software.

In the latter case, each of the above devices is implemented by, for example, a computer that executes commands of a program, that is software for implementing each function. An example of such a computer (hereinafter described as a computer C) is illustrated in FIG. 13. FIG. 13 is a block diagram illustrating a hardware configuration of the computer C functioning as each of the above devices.

The computer C includes at least one processor C1 and at least one memory C2. A program (concealment support program) P for operating the computer C as each of the above devices is recorded in the memory C2. In the computer C, by the processor C1 reading the program P from the memory C2 and executing the program P, each function of each of the above apparatuses is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for sending and receiving data to and from another apparatus. In addition, the computer C may further include an input/output interface for connecting input/output devices such as a keyboard, a mouse, a display, and a printer.

Furthermore, the program P can be recorded on a non-transitory tangible recording medium M readable by the computer C.

Examples of the recording media M include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), cards, programable logic circuits and semiconductor memories (such as mask ROM, PROM (programmable ROM), EPROM (erasable PROM), flash ROM, RAM (random access memory), etc.). The computer C can obtain the program P with the recording media M. In addition, the program P may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. The computer C can obtain the program P with the transitory computer readable media.

The functions of each of the above devices may be implemented by a single processor provided in a single computer, may be implemented, in cooperation, by a plurality of processors provided in a single computer, or may be implemented, in cooperation, by a plurality of processors provided in each of a plurality of computers. The program for causing each of the above devices to implement the functions described above may be stored in a single memory provided in a single computer, may be stored in a distributed manner in a plurality of memories provided in a single computer, or may be stored in a distributed manner in a plurality of memories provided in each of a plurality of computers.

### Supplementary Notes

The present disclosure includes the technologies described in the following supplementary notes. However, the present disclosure is not limited to the techniques described in the following supplementary notes, and various modifications can be made within the scope described in the claims.

### (Supplementary Note A1)

An information processing device including a data acquisition means for acquiring target data that may include a matter to be concealed, and a target portion estimation means for estimating a target portion to be concealed in the target data using a language model trained with machine learning.

(supplementary Note A2)

The information processing device according to supplementary note A1, further including: a reception means for receiving an input of a matter desired to be concealed, in which the target portion estimation means generates a prompt for instructing to extract a portion corresponding to the matter from the target data, and estimates the target portion based on an output obtained by inputting the generated prompt to the language model.

### (Supplementary Note A3)

The information processing device according to supplementary note A1 or A2, further including: a presentation control means for presenting the target portion estimated by the target portion estimation means; and a reception means for receiving designation of a target portion to be concealed among the target portions presented by the presentation control means.

### (Supplementary Note A4)

The information processing device according to supplementary note A3, wherein the presentation control means presents a conversion candidate for concealing the target portion, and the reception means receives selection or correction of the conversion candidate, and the information processing device further includes a concealing means for converting the target portion in the target data into the selected conversion candidate to generate concealed data, or converting the target portion in the target data into the corrected conversion candidate to generate concealed data.

### (Supplementary Note A5)

The information processing device according to any one of supplementary notes A1 to A4, further including a mode estimation means for estimating a mode of concealment to be applied to the target portion, using the language model.

### (Supplementary Note A6)

The information processing device according to supplementary note A5, wherein the mode estimation means includes: a presentation control means for causing the language model to generate a plurality of conversion candidates obtained by abstracting the target portion with different abstraction degrees and to present the plurality of conversion candidates generated by the language model; and a reception means for receiving designation of a conversion candidate used for conversion of the target portion among the plurality of conversion candidates presented by the presentation control means.

### (Supplementary Note A7)

The information processing device according to supplementary note A5 or A6, further including a presentation control means for presenting the target portion together with the target data, and presents a mode of concealment to be applied to the target portion, estimated by the mode estimation means, according to an operation of designating the presented target portion.

### (Supplementary Note A8)

An information processing device including: a target portion specifying means for specifying a target portion to be concealed in target data; and a mode estimation means for estimating a mode of concealment to be applied to the target portion specified by the target portion specifying means, using a language model trained with machine learning.

### (Supplementary Note B1)

A concealment support method, wherein at least one processor executes: data acquisition processing of acquiring target data that may include a matter to be concealed; and target portion estimation processing of estimating a target portion that is a portion to be concealed in the target data, using a language model trained with machine learning.

### (Supplementary Note B2)

The concealment support method according to supplementary note B1, wherein the at least one processor executes reception processing of receiving an input of a matter desired to be concealed, and in the target portion estimation processing, the at least one processor generates a prompt for instructing to extract a portion corresponding to the matter from the target data, and estimates the target portion based on an output obtained by inputting the generated prompt to the language model.

### (Supplementary Note B3)

The concealment support method according to supplementary note B1 or B2, wherein the at least one processor executes: presentation control processing of presenting the target portion estimated in the target portion estimation processing; and reception processing of receiving designation of a target portion to be concealed among the target portions presented in the presentation control processing.

### (Supplementary Note B4)

The concealment support method according to supplementary note B3, wherein the at least one processor executes concealment processing of presenting a conversion candidate for concealing the target portion, receiving selection or correction of the conversion candidate, and converting the target portion in the target data into the selected conversion candidate to generate concealed data, or converting the target portion in the target data into the corrected conversion candidate to generate concealed data.

### (Supplementary Note B5)

The concealment support method according to any one of supplementary notes B1 to B4, wherein the at least one processor executes mode estimation processing of estimating a mode of concealment to be applied to the target portion by using the language model.

### (Supplementary Note B6)

The concealment support method according to supplementary note B5, wherein in the mode estimation processing, the at least one processor causes the language model to generate a plurality of conversion candidates obtained by abstracting the target portion with different abstraction degrees, and the at least one processor presents the plurality of conversion candidates generated by the language model, and receives designation of a conversion candidate used for conversion of the target portion among the plurality of presented conversion candidates.

### (Supplementary Note B7)

The concealment support method according to supplementary note B5 or B6, wherein the at least one processor executes presentation control processing of presenting the target portion together with the target data, and presenting a mode of concealment to be applied to the target portion, estimated by the mode estimation processing, according to an operation of designating the presented target portion.

### (Supplementary Note B8)

A concealment support method wherein at least one processor executes target portion specifying processing of specifying a target portion to be concealed in target data, and mode estimation processing of estimating a mode of concealment to be applied to the target portion specified in the target portion specifying processing, using a language model trained with machine learning.

### (Supplementary Note C1)

A concealment support program causing a computer to function as: a data acquisition means for acquiring target data that may include a matter to be concealed; and a target portion estimation means for estimating a target portion that is a portion to be concealed in the target data, using a language model trained with machine learning.

### (Supplementary Note C2)

The concealment support program according to supplementary note C1, causing the computer to function as a reception means for receiving an input of a matter desired to be concealed, in which the target portion estimation means generates a prompt for instructing to extract a portion corresponding to the matter from the target data, and estimates the target portion based on an output obtained by inputting the generated prompt to the language model.

### (Supplementary Note C3)

The concealment support program according to supplementary note C1 or C2, causing the computer to function as: a presentation control means for presenting the target portion estimated by the target portion estimation means; and a reception means for receiving designation of a target portion to be concealed among the target portions presented by the presentation control means.

### (Supplementary Note C4)

The concealment support program according to supplementary note C3, wherein the presentation control means presents a conversion candidate for concealing the target portion, and the reception means receives selection or correction of the conversion candidate to cause the computer to function as a concealing means for converting the target portion in the target data into the selected conversion candidate to generate concealed data, or converting the target portion in the target data into the corrected conversion candidate to generate concealed data.

### (Supplementary Note C5)

The concealment support program according to any one of supplementary notes C1 to C4, causing the computer to function as a mode estimation means for estimating a mode of concealment to be applied to the target portion by using the language model.

### (Supplementary Note C6)

The concealment support program according to supplementary note C5, wherein the mode estimation means causes the language model to generate a plurality of conversion candidates obtained by abstracting the target portion with different abstraction degrees and causes the computer to function as: a presentation control means for presenting the plurality of conversion candidates generated by the language model; and a reception means for receiving designation of a conversion candidate used for conversion of the target portion among the plurality of conversion candidates presented by the presentation control means.

(supplementary Note C7)

The concealment support program according to supplementary note C5 or C6, causing the computer to function as a presentation control means for presenting the target portion together with the target data, and presenting a mode of concealment to be applied to the target portion, estimated by the mode estimation means, according to an operation of designating the presented target portion.

(supplementary Note C8)

A concealment support program causing a computer to function as: a target portion specifying means for specifying a target portion to be concealed in target data; and a mode estimation means for estimating a mode of concealment to be applied to the target portion specified by the target portion specifying means, using a language model trained with machine learning.

(supplementary Note D1)

An information processing device including at least one processor, wherein the at least one processor executes data acquisition processing of acquiring target data that may include a matter to be concealed; and target portion estimation processing of estimating a target portion that is a portion to be concealed in the target data, using a language model trained with machine learning.

The information processing device may further include a memory. The memory may store a program for causing the at least one processor to execute each type of the processing.

(supplementary Note D2)

The information processing device according to supplementary note D1, wherein the at least one processor executes reception processing of receiving an input of a matter desired to be concealed, and in the target portion estimation processing, the at least one processor generates a prompt for instructing to extract a portion corresponding to the matter from the target data, and estimates the target portion based on an output obtained by inputting the generated prompt to the language model.

### (Supplementary Note D3)

The information processing device according to supplementary note D1 or D2, wherein the at least one processor executes: presentation control processing of presenting the target portion estimated in the target portion estimation processing; and reception processing of receiving designation of a target portion to be concealed among the target portions presented in the presentation control processing.

### (Supplementary Note D4)

The information processing device according to supplementary note D3, wherein the at least one processor executes concealment processing of presenting a conversion candidate for concealing the target portion, receiving selection or correction of the conversion candidate, and converting the target portion in the target data into the selected conversion candidate to generate concealed data, or converting the target portion in the target data into the corrected conversion candidate to generate concealed data.

### (Supplementary Note D5)

The information processing device according to any one of supplementary notes D1 to D4, wherein the at least one processor executes mode estimation processing of estimating a mode of concealment to be applied to the target portion by using the language model.

### (Supplementary Note D6)

The information processing device according to supplementary note D5, wherein in the mode estimation processing, the at least one processor causes the language model to generate a plurality of conversion candidates obtained by abstracting the target portion with different abstraction degrees, and the at least one processor presents the plurality of conversion candidates generated by the language model, and receives designation of a conversion candidate used for conversion of the target portion among the plurality of presented conversion candidates.

### (Supplementary Note D7)

The information processing device according to supplementary note D5 or D6, wherein the at least one processor presents the target portion together with the target data, and presents a mode of concealment to be applied to the target portion, estimated by the mode estimation processing, according to an operation of designating the presented target portion.

### (Supplementary Note D8)

An information processing device including at least one processor, wherein the at least one processor executes target portion specifying processing of specifying a target portion to be concealed in target data, and mode estimation processing of estimating a mode of concealment to be applied to the target portion specified in the target portion specifying processing using a language model trained with machine learning.

### (Supplementary Note E1)

A non-transitory recording medium recording a concealment support program for causing a computer to execute: data acquisition processing of acquiring target data that may include a matter to be concealed; and target portion estimation processing of estimating a target portion that is a portion to be concealed in the target data, using a language model trained with machine learning.

### (Supplementary Note E2)

A non-transitory recording medium recording a concealment support program for causing a computer to execute: target portion specifying processing of specifying a target portion to be concealed in target data, and mode estimation processing of estimating a mode of concealment to be applied to the target portion specified in the target portion specifying processing, using a language model trained with machine learning.

What is claimed is:

1. An information processing device comprising:
one or more memories for storing instructions; and
one or more processors for executing the instructions,
wherein the one or more processors execute the instructions to:
acquire target data that may include a matter to be concealed, and
estimate a target portion that is a portion to be concealed in the target data, using a language model trained with machine learning.

2. The information processing device according to claim 1, wherein the one or more processors execute the instructions to:
receive an input of a matter desired to be concealed, and
generate a prompt for instructing to extract a portion corresponding to the matter from the target data, and estimate the target portion based on an output obtained by inputting the generated prompt to the language model.

3. The information processing device according to claim 1, wherein the one or more processors execute the instructions to:
present the estimated target portion; and
receive designation of a target portion to be concealed among the presented target portions.

4. The information processing device according to claim 3, wherein the one or more processors execute the instructions to:
present a conversion candidate for concealing the target portion,
receive selection or correction of the conversion candidate, and
convert the target portion in the target data into the selected conversion candidate to generate concealed data, or convert the target portion in the target data into the corrected conversion candidate to generate concealed data.

5. The information processing device according to claim 1, wherein the one or more processors execute the instructions to estimate a mode of concealment to be applied to the target portion using the language model.

6. The information processing device according to claim 5, wherein the one or more processors execute the instructions to:
cause the language model to generate a plurality of conversion candidates obtained by abstracting the target portion with different abstraction degrees, and
present the plurality of conversion candidates generated by the language model, and
receive designation of a conversion candidate used for conversion of the target portion among the plurality of presented conversion candidates.

7. The information processing device according to claim 5, wherein the one or more processors execute the instructions to present the target portion together with the target data, and present an estimated mode of concealment to be applied to the target portion, according to an operation of designating the presented target portion.

8. An information processing device comprising:
one or more memories for storing instructions; and
one or more processors for executing the instructions,
wherein the one or more processors execute the instructions to:
specify a target portion to be concealed in target data; and
estimate a mode of concealment to be applied to the specified target portion using a language model trained with machine learning.

9. A concealment support method, wherein at least one processor executes:
data acquisition processing of acquiring target data that may include a matter to be concealed; and
target portion estimation processing of estimating a target portion that is a portion to be concealed in the target data, using a language model trained with machine learning.
